(19) United States
(12) Patent Application Publication
(10) Pub. No.: US 2011/0031881 A1
(43) Pub. Date: Feb. 10, 2011

(54) ELECTRICAL WALL OUTLET WITH LED INDICATOR

(76) Inventor: Henry Hyunbo SHIM, Los Angeles, CA (US)

Correspondence Address: PARK LAW FIRM, 3255 WILSHIRE BLVD, SUITE 1110, LOS ANGELES, CA, 90010, US

(21) Appl. No.: 12/537,813

(22) Filed: Aug. 7, 2009

(51) Int. Cl. H01K 1/62; F21V 33/00; H05B 37/02; H01R 11/30

(52) U.S. Cl. 315/32; 362/253; 315/159; 439/39

(57) ABSTRACT

An electrical wall outlet comprises an insulating cover portion, LEDs, and a pair of magnetic electrodes. The insulating cover portion encloses outlet electrodes of the wall outlet. The one or more outlet electrodes are ferrous. The LEDs are disposed on the front surface of the insulating cover portion. The pair of magnetic electrodes are disposed on the rear surface of the insulating cover portion, extending from a pair of common terminals of the LEDs that are disposed on the insulating cover portion, toward to one of the one or more outlet electrodes of the electrical wall outlet. The pair of magnetic electrodes are flexible to bend. Also, the pair of magnetic electrodes are resilient to recover when the insulating cover portion is plucked out.

### BACKGROUND OF THE INVENTION

The present invention relates to an electrical wall outlet with LED indicator. More particularly, this invention relates to an electrical wall outlet with LED indicator which makes the device visible in the dark.

Due to the fact that human can see light of a particular frequency range, darkness and therefore night has overshadowed human activities and limited the temporal and spatial ranges thereof.

The electrical wall outlet or switch with LED indicator is able to help the people in the dark in many situations.

There are many aspects in the conventional night-glow device in installing and operating.

Accordingly, a need for electrical wall outlet with LED indicator has been present for a long time considering the wide range of potential application. This invention is directed to satisfy the long-felt need.

### SUMMARY OF THE INVENTION

An objective of the invention is to provide an electrical wall outlet with LED indicator.

Another object of the invention is to provide electrical wall outlet with LED indicator, which can be easily installed.

Still another object of the invention is to provide an electrical wall outlet with LED indicator, which can be easily applicable to the prior arts.

An aspect of the invention provides an electrical wall outlet with LED indicator provides a night-glow power outlet.

The electrical wall outlet comprises an insulating cover portion, a plurality of LEDs, and a pair of magnetic electrodes.

The insulating cover portion is configured for enclosing one or more outlet electrodes of the electrical wall outlet. The insulating cover portion comprises a front surface and a rear surface, and the one or more outlet electrodes are ferrous.

The plurality of LEDs are disposed on the front surface of the insulating cover portion, and the plurality of LEDs are connected with one another in parallel.

The pair of magnetic electrodes are disposed on the rear surface of the insulating cover portion, extending from a pair of common terminals of the LEDs that are disposed on the insulating cover portion, toward to one of the one or more outlet electrodes of the electrical wall outlet. The pair of magnetic electrodes are flexible to bend. Also, the pair of magnetic electrodes are resilient to recover when the insulating cover portion is plucked out.

The pair of magnetic electrodes are attracted and connected electrically to the one of the one or more outlet electrodes of the electrical wall outlet on approaching the insulating cover portion over the one or more outlet electrodes of the electrical wall outlet, such that that the plurality of LEDs are powered by the wall outlet.

At least one of the one or more outlet electrodes may comprise a connecting receptacle configured for accepting one of the pair of magnetic electrodes, and the connecting receptacle may be ferrous.

Each of the pair of magnetic electrodes may comprise a contacting arm extending vertically from the rear surface of the insulating cover portion.

The contacting arm of the magnetic electrode may comprise a magnetic end.

The electrical wall outlet may further comprise a rectifying circuit for providing DC to the LEDs. The rectifying circuit may comprise a diode and a capacitor.

The electrical wall outlet may further comprise a photo resistor sensor for sensing ambient light and turning on and off the LEDs.

Another aspect of the invention provides an electrical wall outlet comprising, instead of LEDs, a plurality of neon lamps disposed on the front surface of the insulating cover portion, wherein the plurality of neon lamps are connected with one another in parallel.

The electrical wall outlet may further comprise a control circuit for controlling operation of the neon lamps. The control circuit may be configured to control operation time of the neon lamps.

The electrical wall outlet may further comprise a photo resistor sensor for sensing ambient light and turning on and off the neon lamps.

Still another aspect of the invention provides an electrical switch comprising an insulating cover portion configured for enclosing terminals of the electrical switch, wherein the insulating cover portion comprises a front surface and a rear surface, and wherein the terminals are ferrous. The other features are almost same as the embodiments of electrical wall outlet.

In certain embodiments of the invention, the LEDs are powered only when the electrical switch is off.

In still another aspect of the invention, a integrated circuit disposed on the front surface of the insulating cover portion may be used instead of the LEDs. The integrated circuit comprises an LED digital clock, which can provides illumination around the wall outlet or switch in the dark.

The advantages of the present invention are: (1) the electrical wall outlet with LED indicator helps people using a plurality of devices in the dark; (2) the electrical wall outlet with LED indicator is easy to install; (3) the electrical wall outlet with LED indicator is applicable to the prior arts with minimal change.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective front view of an electrical wall outlet according to an embodiment of the invention;

FIG. 2 is a perspective front view of the electrical wall outlet of FIG. 1;

FIG. 3 is a perspective rear view of the electrical wall outlet of FIG. 1;

FIG. 4 is a cross-sectional view along the line IV-IV in FIG. 3, illustrating magnetic electrodes according to an embodiment of the invention;

FIG. 5 is a circuit diagram for an electrical wall outlet with LED indicators according an embodiment of the invention;

FIG. 6 is a circuit diagram for an electrical wall outlet with neon lamps according another embodiment of the invention;

FIG. 7 is a circuit diagram for an electrical wall outlet with a photo resistor sensor according to still another embodiment of the invention;

FIG. 8 is a circuit diagram for an electrical wall cutlet with an integrated circuit with an LED digital clock according to still another embodiment of the invention;

FIG. 9 is a perspective front view of an electrical switch according to another embodiment of the invention;

FIG. 10 is a cross-sectional view along the line X-X of FIG. 9; and

FIG. 11 is a cross-sectional view of an insulating cover portion and magnetic electrodes in FIG. 10.

### DETAILED DESCRIPTION EMBODIMENTS OF THE INVENTION

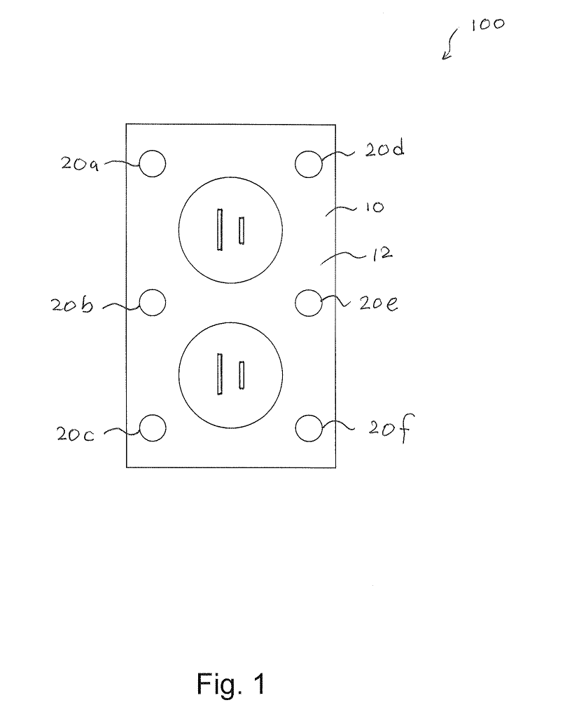

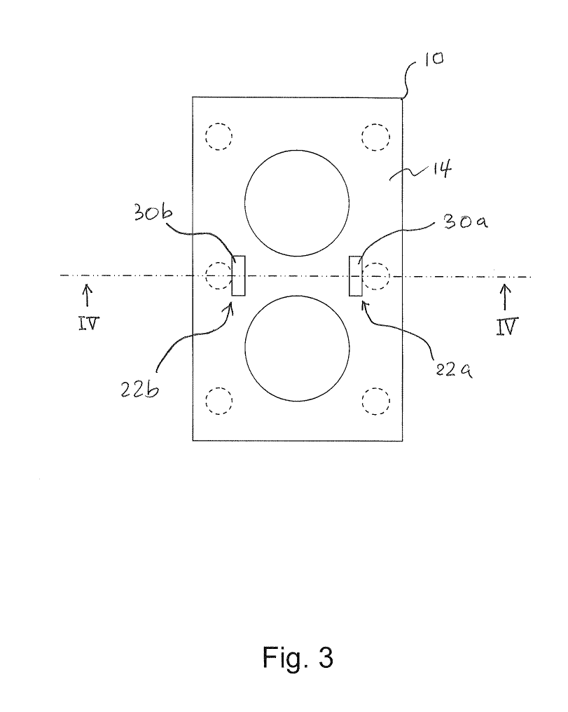

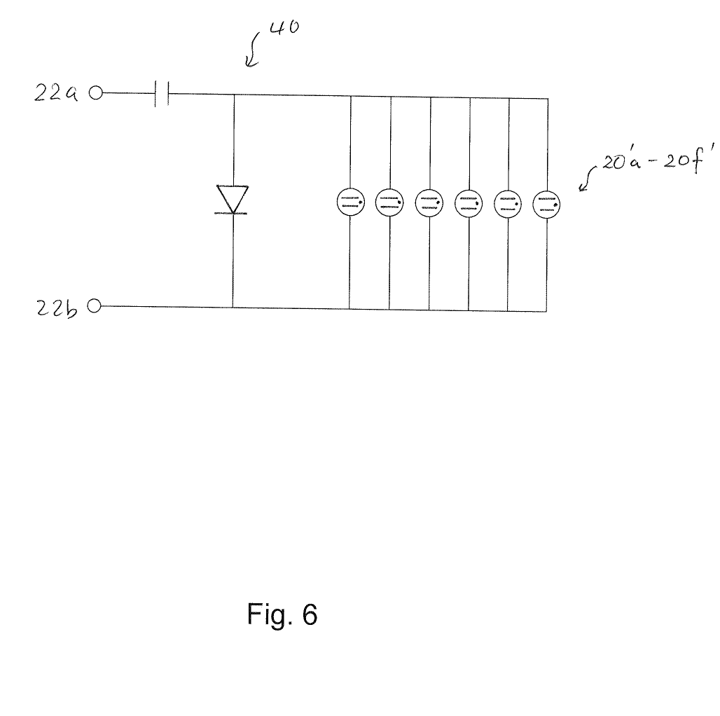

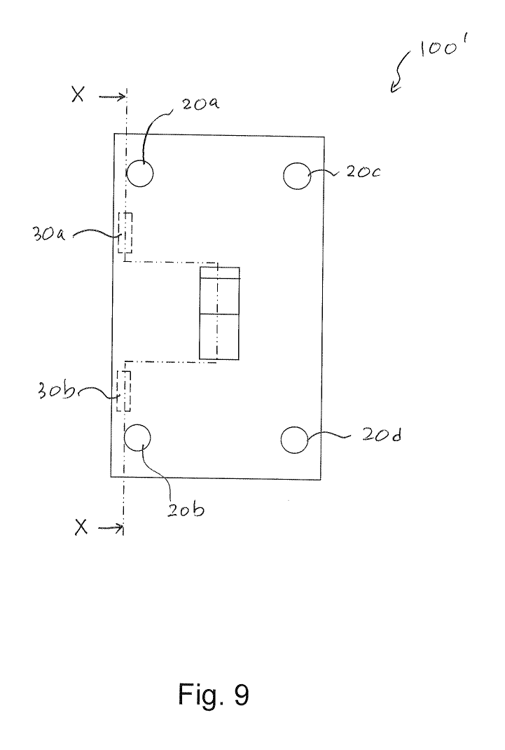

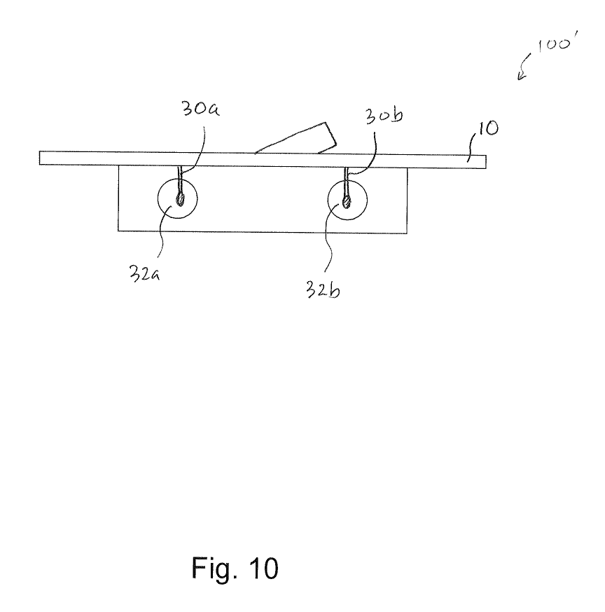

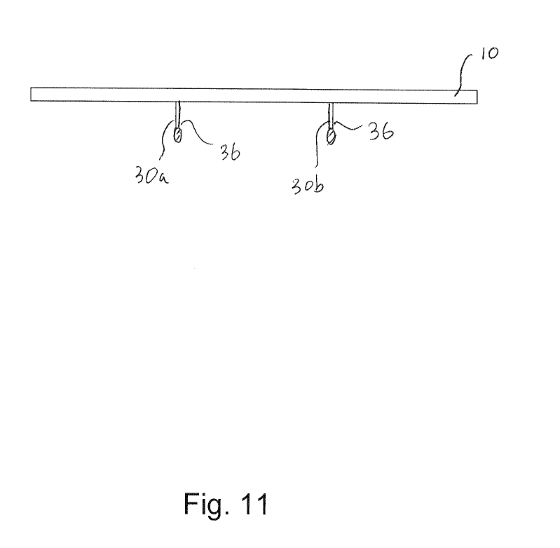

FIGS. 1-8 show electrical wall outlets according to embodiments of the invention, and FIGS. 9-11 show an electrical switch.

An aspect of the invention provides an electrical wall outlet 100 with LED indicator provides a night-glow power outlet.

Referring to FIGS. 1-4, the electrical wall outlet 100 comprises an insulating cover portion 10, a plurality of LEDs 20a-20f, and a pair of magnetic electrodes 30a, 30b.

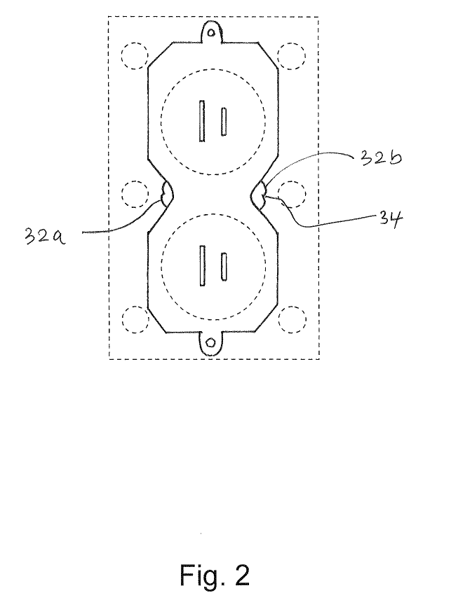

The insulating cover portion 10 is configured for enclosing one or more outlet electrodes 32a, 32b of the electrical wall outlet 100 as shown in FIG. 2. The insulating cover portion 10 comprises a front surface 12 and a rear surface 14, and the one or more outlet electrodes 32a, 32b are ferrous.

The plurality of LEDs 20a-20f are disposed on the front surface 12 of the insulating cover portion 10, and the plurality of LEDs 20a-20f are connected with one another in parallel.

The pair of magnetic electrodes 30a, 30b are disposed on the rear surface 14 of the insulating cover portion 10, extending from a pair of common terminals 22a, 22b of the LEDs 20a-20f that are disposed on the insulating cover portion 10, toward to one of the one or more outlet electrodes 32a, 32b of the electrical wall outlet. The pair of magnetic electrodes 30a, 30b are flexible to bend. Also, the pair of magnetic electrodes 30a, 30b are resilient to recover when the insulating cover portion 10 is plucked out.

The pair of magnetic electrodes 30a, 30b are attracted and connected electrically to the one of the one or more outlet electrodes 32a, 32b of the electrical wall outlet on approaching the insulating cover portion 10 over the one or more outlet electrodes 32a, 32b of the electrical wall outlet, such that that the plurality of LEDs 20a-20f are powered by the wall outlet.

At least one of the one or more outlet electrodes 32a, 32b may comprise a connecting receptacle 34 configured for accepting one of the pair of magnetic electrodes 30a, 30b, as shown in FIG. 2, and the connecting receptacle 34 may be ferrous. In certain embodiments, the connecting receptacle 34 may be formed as a groove adapted to accept the pair of magnetic electrodes 30a, 30b as shown in FIG. 2, which may add a mechanically accepting function in addition to magnetic attraction.

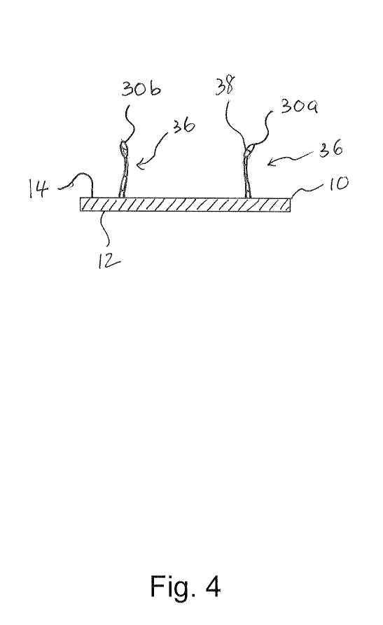

Each of the pair of magnetic electrodes 30a, 30b may comprise a contacting arm 36 extending vertically from the rear surface of the insulating cover portion 10 as shown in FIG. 4.

The contacting arm 36 of the magnetic electrode 30a, 30b may comprise a magnetic end 38. That is, the whole contacting arm 36 may not be magnetic, but only a portion, for example, a head portion of it may comprise a magnet or magnetized portion.

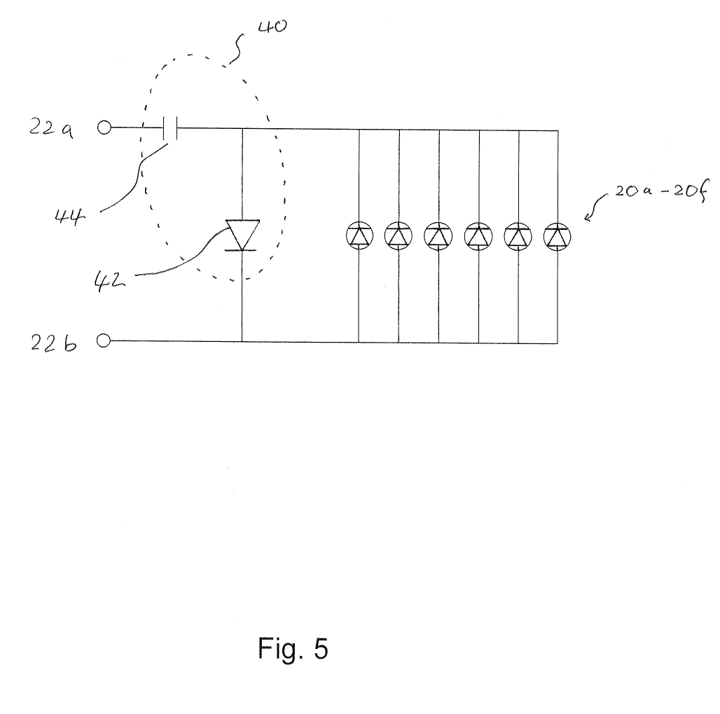

The electrical wall outlet 100 may further comprise a rectifying circuit 40 for providing DC to the LEDs 20a-20f as shown in FIG. 5-8. The rectifying circuit 40 may comprise a diode 42 and a capacitor 44. However, in certain embodiments, the rectifying circuit 40 may comprise other electrical component or technology. The rectifying circuit 40 may be disposed on the rear surface 14 of the insulating cover portion 10. Alternatively, the rectifying circuit 40 may be embedded in the insulating cover portion 10. The LEDs 20a-20f also may be embedded in the insulating cover portion 10.

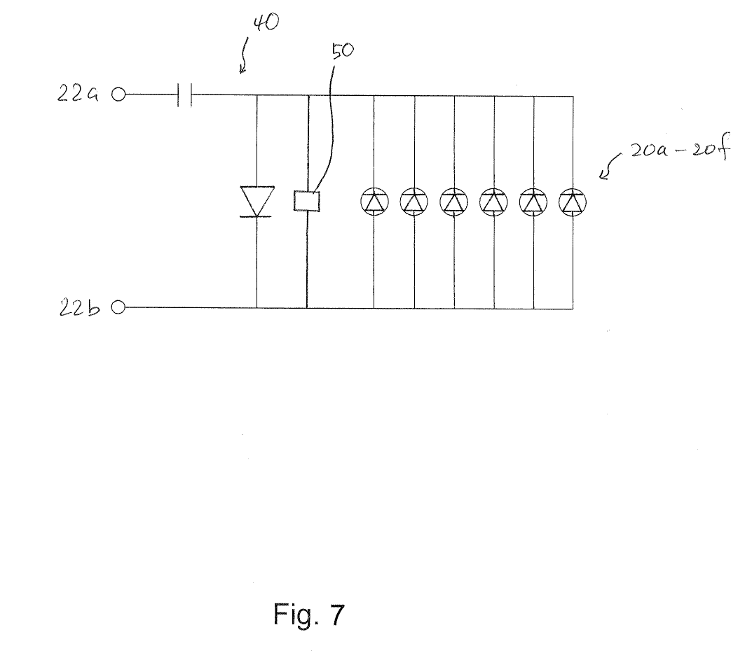

The electrical wall outlet 100 may further comprise a photo resistor sensor 50 for sensing ambient light and turning on and off the LEDs 20a-20f as shown in FIG. 7. That is, when the ambient illumination is above a predetermined magnitude, the night glow system may be inactivated.

Another aspect of the invention provides an electrical wall outlet 100 comprising, instead of LEDs 20a-20f, a plurality of neon lamps 20a′-20f′ disposed on the front surface 12 of the insulating cover portion 10, wherein the plurality of neon lamps 20a′-20f′ are connected with one another in parallel.

The electrical wall outlet 100 may further comprise a photo resistor sensor 50 for sensing ambient light and turning on and off the neon lamps 20a′-20f′ as shown in FIG. 7.

Still another aspect of the invention provides an electrical switch 100′ comprising an insulating cover portion 10 configured for enclosing terminals of the electrical switch 100′, wherein the insulating cover portion 10 comprises a front surface 12 and a rear surface 14 as shown in FIGS. 9-11. The other features including the LEDs 20a-20d, magnetic electrodes 30a, 30b, outlet electrodes 32a, 32b, connecting receptacle 34, and contacting arm 36 are almost same as the embodiments of electrical wall outlet 100.

In certain embodiments of the invention, the LEDs 20a-20f are powered only when the electrical switch 100′ is off.

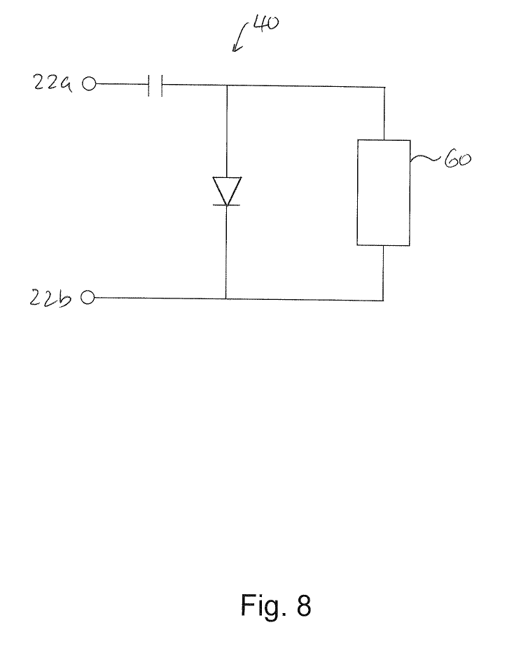

In still another aspect of the invention, a integrated circuit 60 disposed on the front surface 12 of the insulating cover portion 10 may be used instead of the LEDs 20a-20f as shown in FIG. 8. The integrated circuit 60 comprises an LED digital clock, which can provides illumination around the wall outlet or switch in the dark. Also, in certain embodiments, the integrated circuit 60 may comprise additional control circuit (not shown) for controlling operation of the digital clock and other conventional functions.

The electrical wall outlet or switch 100, 100′ according to the invention is very easy to apply to the conventional wall outlet or switch 100, 100′. It can be done just by replacing the conventional cover portion with one according to the invention. This wall outlet and switch can be applicable irrespective of 110V or 220V system.

The capacitor 44 of the rectifying circuit 42 may be 0.1 μF150VAC in order to provide 0.56V DC to the LEDs. For the neon lamps, the capacitor 44 may be 0.047 μF150VAC to provide 30V AC.

The diode 42 may comprise a regular AC rectifier diode.

The LEDs 20a-20f may comprise SMD-LED and REG-LED according to color, voltage current ratings, shapes, etc.

The neon lamps 20a′-20f′ may comprise NE-2 type.

The photo resistor 50 may provide a resistance of at least 5KΩ for the neon lamps, and at least 33Ω for LEDs for turning off the indicators.

However, all these values for capacitors, LEDs, diodes, neon lamps, photo resistors may be changed and optimized for different design spec of the problem to solve.

The number or location of the LEDs or neon lamps may be adapted to necessity or situations. In certain embodiments, the LEDs or neon lamps may be provided as a form of print circuit. Alternatively, they may be provided as a block combined with the diode 42 and the capacitor 44.

The electrical connections can b accommodated to details of deign without leaving the inventive points of the invention.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An electrical wall outlet comprising:
an insulating cover portion configured for enclosing one or more outlet electrodes of the electrical wall outlet, wherein the insulating cover portion comprises a front surface and a rear surface, and wherein the one or more outlet electrodes are ferrous;
a plurality of LEDs disposed on the front surface of the insulating cover portion, wherein the plurality of LEDs are connected with one another in parallel; and
a pair of magnetic electrodes disposed on the rear surface of the insulating cover portion, extending from a pair of common terminals of the LEDs that are disposed on the insulating cover portion, toward to one of the one or more outlet electrodes of the electrical wall outlet,
wherein the pair of magnetic electrodes are attracted and connected electrically to the one of the one or more outlet electrodes of the electrical wall outlet on approaching the insulating cover portion over the one or more outlet electrodes of the electrical wall outlet, such that that the plurality of LEDs are powered by the wall outlet.

2. The electrical wall outlet of claim 1, wherein at least one of the one or more outlet electrodes comprises a connecting receptacle configured for accepting one of the pair of magnetic electrodes, wherein the connecting receptacle is ferrous.

3. The electrical wall outlet of claim 2, wherein each of the pair of magnetic electrodes comprises a contacting arm extending vertically from the rear surface of the insulating cover portion.

4. The electrical wall outlet of claim 3, wherein the contacting arm of the magnetic electrode comprises a magnetic end.

5. The electrical wall outlet of claim 1, further comprising a rectifying circuit for providing DC to the LEDs.

6. The electrical wall outlet of claim 5, wherein the rectifying circuit comprises a diode and a capacitor.

7. The electrical wall outlet of claim 1, wherein the pair of magnetic electrodes are flexible to bend.

8. The electrical wall outlet of claim 7, wherein the pair of magnetic electrodes are resilient to recover on plucking out the insulating cover portion.

9. The electrical wall outlet of claim 8, further comprising a photo resistor sensor for sensing ambient light and turning on and off the LEDs.

10. An electrical wall outlet comprising:
an insulating cover portion configured for enclosing one or more outlet electrodes of the electrical wall outlet, wherein the insulating cover portion comprises a front surface and a rear surface, and wherein the one or more outlet electrodes are ferrous;
a plurality of neon lamps disposed on the front surface of the insulating cover portion, wherein the plurality of neon lamps are connected with one another in parallel; and
a pair of magnetic electrodes disposed on the rear surface of the insulating cover portion, extending from a pair of common terminals of the neon lamps that are disposed on the insulating cover portion, toward to one of the one or more outlet electrodes of the electrical wall outlet, wherein the pair of magnetic electrodes are flexible to bend,
wherein the pair of magnetic electrodes are attracted and connected electrically to the one of the one or more outlet electrodes of the electrical wall outlet on approaching the insulating cover portion over the one or more outlet electrodes of the electrical wall outlet, such that that the plurality of neon lamps are powered by the wall outlet.

11. The electrical wall outlet of claim 10, wherein the pair of magnetic electrodes are flexible to bend.

12. The electrical wall outlet of claim 11, wherein the pair of magnetic electrodes are resilient to recover on plucking out the insulating cover portion.

13. The electrical wall outlet of claim 10, further comprising a photo resistor sensor for sensing ambient light and turning on and off the neon lamps.

14. An electrical switch comprising:
an insulating cover portion configured for enclosing terminals of the electrical switch, wherein the insulating cover portion comprises a front surface and a rear surface, and wherein the terminals are ferrous;
a plurality of LEDs disposed on the front surface of the insulating cover portion, wherein the plurality of LEDs are connected with one another in parallel; and
a pair of magnetic electrodes disposed on the rear surface of the insulating cover portion, extending from a pair of common terminals of the LEDs that are disposed on the insulating cover portion, toward to one of wall outlet electrodes, wherein the pair of magnetic electrodes are flexible to bend,
wherein the pair of magnetic electrodes are attracted and connected electrically to the one of the wall outlet electrodes on approaching the insulating cover portion over the terminals of the electrical switch, such that that the plurality of LEDs are powered by the switch.

15. The electrical switch of claim 14, wherein at least one of the terminals comprises a connecting receptacle configured for accepting one of the pair of magnetic electrodes, wherein the connecting receptacle is ferrous.

16. The electrical switch of claim 15, wherein each of the pair of magnetic electrodes comprises a contacting arm extending vertically from the rear surface of the insulating cover portion.

17. The electrical switch of claim 16, wherein the contacting arm of the magnetic electrode comprises a magnetic end.

18. The electrical switch of claim 14, wherein the LEDs are powered only when the electrical switch is off.

19. An electrical wall outlet comprising:
an insulating cover portion configured for enclosing one or more outlet electrodes of the electrical wall outlet, wherein the insulating cover portion comprises a front surface and a rear surface, and wherein the one or more outlet electrodes are ferrous;
a integrated circuit disposed on the front surface of the insulating cover portion, wherein the integrated circuit comprises an LED digital clock; and
a pair of magnetic electrodes disposed on the rear surface of the insulating cover portion, extending from a pair of power input terminals of the integrated circuit, toward to one of the one or more outlet electrodes of the electrical wall outlet,
wherein the pair of magnetic electrodes are attracted and connected electrically to the one of the one or more outlet electrodes of the electrical wall outlet on approaching the insulating cover portion over the one or more outlet electrodes of the electrical wall outlet, such that that the integrated circuit is powered by the wall outlet.
